(19) United States
(12) Patent Application Publication
(10) Pub. No.: US 2023/0092542 A1
(43) Pub. Date: Mar. 23, 2023

(54) INJECTION MOLDING TOOL AND METHOD FOR PRODUCING MOLDED PARTS

(71) Applicant: Georg Kaufmann Formenbau AG, Busslingen (CH)

(72) Inventors: Richard LEBER, Weilheim-Noeggenschwiel (DE); Alex HAGENBUCH, Berikon (CH); Martin SCHOENAUER, Stetten (CH); Roman HUERLIMANN, Zufikon (CH)

(73) Assignee: Georg Kaufmann Formenbau AG, Busslingen (CH)

(21) Appl. No.: 17/795,727

(22) PCT Filed: Jan. 26, 2021
(86) PCT No.: PCT/EP2021/025029

§ 371 Date: Aug. 19, 2022

(30) Foreign Application Priority Data
Feb. 3, 2020 (CH) 00119/20

(51) Int. Cl. B29C 45/14; B29C 43/18; B29C 43/36; B29C 43/40

(52) U.S. Cl. CPC B29C 45/14196; B29C 43/183; B29C 43/361; B29C 43/40; B29C 45/14221; B29C 2043/403; B29C 2045/14188

(57) ABSTRACT

A device for producing a composite molded part from planar and support structures includes a matrix, a punch, and a matrix slider, arranged to be movable relative to one another and in a closed state to define a cavity corresponding to the shape of the part to be produced. By and/or on at least one component, an edge folding arrangement is formed having a region fixing and/or pinching off and/or fully severing the decorative structure border. Also, a method for producing a composite molded part includes: providing a device, inserting a planar structure, transferring the device into a closed position and creating a cavity, introducing an uncured support structure, severing a strip of the structure protruding beyond the folded edge border, curing and demolding the composite molded part. Before and/or while introducing the uncured support structure, the planar structure is fixed in the folded edge outer border region.

### CROSS REFERENCE TO RELATED APPLICATIONS

This application is the National Stage of PCT/EP2021/025029 filed on Jan. 26, 2021, which claims priority under 35 U.S.C. § 119 of Switzerland Application No. 00119/20 filed on Feb. 3, 2020, the disclosure of which is incorporated by reference. The international application under PCT article 21(2) was not published in English.

### BACKGROUND OF THE INVENTION

### Field of the Invention

The invention relates to a device for producing a composite molded part, as well as a method for its production.

### Description of the Related Art

When producing molded parts from partial components with different physical properties, said components can be connected in a materially bonded or at least positive-locking manner during the molding process. This approach is used particularly in cases where, for example, materials, which have to meet technical requirements of lightness and/or stability, are additionally to be provided with more pleasing optics and/or haptics.

For this purpose, typically films, decors and/or textiles with the desired optical and/or haptic properties are either preformed or placed into a mold while still in an elastic/flexible state and backfilled with the respective carrier material. In order to ensure that the entire surface to be covered by the film is actually covered by it, this film usually has an overhang extending beyond the border of the molded part, which overhang has to be removed in a separate method step. This may be done manually with great effort, which may lead to damaged goods if, in doing so, the structure of the composite molded part is damaged. Devices which are automated accordingly for removing the protruding border, however, are expensive and complex with regard to maintenance and upkeep, and thus increase operating costs substantially.

An exemplary variant provides for compression molding, in which a flexible film is inlaid and subsequently, a surface structure on a matrix is stamped onto the film. Such a method is disclosed in DE 199 160 23 A1, for example. In this, there is also the immediate attempt to adapt the dimensions of the film to the desired shape of the composite molded part by means of cutting faces. The case is similar in the injection embossing device and the corresponding method according to DE 10 2010 016350 A1. Here, as well, the back-injected film is sheared off during the closing of the molding tools, and such, the film is removed at the transition point from the front side to the rear side of the molded part.

The device according to DE 25 48 318 A1 has a downholder for the film to be coated, which downholder is separate from the molding tools and which also determines the outer circumference of the finished product coated film. By means of a pinch-off edge on said downholder, the film is removed in the border region, meaning again at the transition between the side of the film and the side of the applied material. Such cuts and/or pinch-off edges or shear edges, however, are unsightly at the edges of the composite molded part and possibly require further processing.

A possibility of how to produce a sightly edge in composite molded parts is shown in DE 34 343 66 A1. At the border of the molded part, the film has a folded edge and is guided along an angled pinch-off edge. This causes a predetermined breaking point, at which an excess of the film can be torn off easily. Although this simplifies the production method, the tearing off process to be performed manually can lead to damages to the composite molded part and particularly the decorative film. Generally, the planar structure, usually a decorative film, is back-injected with the material of the support structure, is then trimmed partially in the tool, partially also afterwards, and is then edge-folded in a separate edge folding unit.

The production of the folded edge may, however, also be executed as disclosed in EP 2 554 352 Bl, such that during the closing of the tool, the protruding edge is folded over towards the die by the mold core so that protruding decorative film is edge-folded and fixed directly in the tool. Thus, it is possible to fold edges, for example in the angle of 90° and 180°, directly in the injection molding tool and, upon back-injecting inlays, to still not have to perform post-processing steps on the resulting components.

JP H08 156015 A discloses a device and a method for producing a molded part with a support material and a decorative material applied thereto. The device comprises a matrix and a patrix, wherein vacuum ducts are present in the matrix in order to suction the decorative material onto the matrix. Furthermore, there are also feed channels and feed openings for cooling air present in these shaping parts in order to quickly cool the molded part.

Furthermore, a device for producing a composite molded part consisting of a support structure and a planar decorative structure having a folded edge is known from EP 3 305 497 A1. This device comprises at least two mold elements, matrix and punch, for receiving the decorative structure, and they can be transferred from an open to a closed state. In the closed state, the mold elements define a cavity which corresponds to the shape of the composite molded part to be produced. On one of the mold elements, a cutting edge is formed, by means of which an excess of the composite molded part and/or of the decorative structure can be removed upon transfer from the closed into the open state. A folding edge is formed on a second mold element such that it partially limits the cavity towards the front side.

This device comprises, in the known manner, a matrix for receiving a planar structure, preferably a decorative structure, in a non-composite state, a punch, and a matrix slider. These mold elements are arranged so as to be movable relative to one another, such that in a closed state, they define a cavity together, which cavity essentially corresponds to the shape of the composite molded part to be produced.

An edge folding arrangement having a first curved region defining the folded edge and having a second region, spaced at a distance from the first, fixing and/or pinching off and/or completely severing the edge-folded border of the decorative structure is formed by at least one and/or on at least one region of one of the components matrix slider, punch and/or matrix.

Thus, folded edges of more than 90° can also easily be produced, wherein the planar structure, for example a decorative film, a textile, or the like, is folded in the injection molding tool into a precisely predefined geometry of the folded edge. This may be provided across the entire border of the component, or only in some sections, in which case the tool elements are formed as described only in these regions. Edges within the meaning of the invention may also be present along openings in the interior region of the component, for example in B-pillar trims along the openings for belt adjustment slider or in side trim panels along the openings for loudspeakers or the like.

The inlay is therefore deformed directly in the tool and does not have to be deformed in advance in a separate working step. After back-injecting and demolding, the high-quality component is fully edge-folded and trimmed, wherein the decor is permanently merged with the plastic melt and a later removal due to environmental influences can be precluded. A separate edge folding unit and trimming arrangement, alternatively the manual trimming, can be avoided.

Thus, there is a necessity for a device and a corresponding method, which allow composite molded parts with planar decorative structures to be demolded as easily as possible and in one stop while being relieved of the excess material of the decorative structure.

### SUMMARY OF THE INVENTION

It is thus the object of the present invention, to remedy the shortcomings of the known device as well as the known method and particularly to provide a device and a method which allow producing a composite molded part with a folded-edge planar structure efficiently and with high quality.

This object is achieved by means of a device and a method according to the invention.

In order to achieve this object, the device according to the invention is characterized in that the punch has an element for fixing the planar structure, movable in a parallel direction with the slider in its region facing the matrix slider. Thus, the border region of the planar structure can be fixed between these two components movable in parallel with one another, the matrix slider and an advancing tool movable in parallel and can be edge-folded in a targeted manner and to a predefined degree in the course of closing the molding tool.

In this regard, it is preferred that in the second region, at least one of the components matrix slider, punch, or matrix has a cutting edge, which bridges a distance to an opposite component to at least 80% in a closed state. Instead of a continuous cutting edge, individual pins may also be provided for achieving a perforation of the material of the planar structure. Thus, a weakening of the material of the decorative structure is caused in order to be able to remove it easily and with little effort. Preferably, this cutting edge is formed on the slider. The cutting edge preferably bridges at least 90%, particularly preferably at least 95% until almost contacting the opposite surface of the opposite component in order to allow for as easy a removal as possible of the protruding border strip of the decorative structure.

According to a further embodiment, the invention is characterized in that the matrix and the matrix slider, in the closed state, together form the first region of the cavity defining the folded edge, and the cutting edge is formed on a border of the matrix slider facing the punch. Due to this constructional arrangement, it is possible to also remove the protruding border of the decorative structure or at least prepare it for removal simultaneously with or directly after closing the molding tool. Preferably, a cutting edge is arranged on an offset border of the slider for this purpose.

An advantageous embodiment of the invention provides that the element movable in a parallel direction with the matrix slider is an advancing tool, wherein the matrix slider and the advancing tool are movable independently of one another.

A further embodiment of a device according to the invention provides that the matrix has at least one suction opening leading out of the cavity, which suction opening can be connected to a device for air extraction. On the one hand, the planar structure is thus sucked into the edge folding region and is laid in its curved section to create a precisely defined folded edge, and on the other hand, the structure is thereby also fixed in the matrix.

On the other hand, it is also possible according to the present invention that the punch has at least one compressed air feed leading into the cavity and connectable to a compressed air source. This constructional embodiment presses the planar structure onto the matrix, in particular in the region of the border with the folded edge, which can thereby be produced in a very targeted manner.

In order to show the effect of both the applied vacuum and the compressed air that is blown in even better, it is possible according to a preferred advancement of the abovementioned device for a seal to be installed on the side wall of the punch, directly adjoining the contact point with the matrix slider on the outside of the cavity.

According to a further embodiment according to the invention, the punch has an element movable in a parallel direction with the matrix in its region facing the matrix slider, which element has an edge projecting into the edge folding region, or a corresponding rake or comb, which are possibly extendable in the direction of the curved region. In this variant, the decorative film or any other planar structure is mechanically pressed into the edge folding region when the molding tool is closed, in order to obtain the precisely defined geometry and width of the folded edge, as in all other variants.

Supportingly, or in case of a suitable property of the planar decorative structure, an application of the structure on the surface of the matrix may also be achieved by means of a heating arrangement for the planar structure, which heating arrangement results in a softening and clinging to the contour even in the edge-folded region, due to the weight of the decorative film alone. All other types of defined production of the folded edge by means of active fixating and carrying along the edge-folded border region when closing the molding tool may also be supported by softening the heated decorative film. Preferably, at least one a heating arrangement is provided for this purpose, which heating arrangement may preferably be arranged externally or on at least one of the components matrix, slider and/or punch.

All of the embodiments of the device mentioned above may also be used in any desired combinations with one another.

A method for producing a composite molded part with a planar structure, preferably decorative structure, enveloping at least a part of the surface of the composite molded part and an at least partially injected support structure comprises the steps of:

a) providing a device with at least a punch, a matrix, and a slider in an open position;

b1) inserting a not yet composite planar structure into the device, such that the planar structure corresponds to at least a part of a contour of the composite molded part to be obtained;

b2) optionally using a planar structure partially preformed with a folded edge;

c) transferring the device into a closed position and creating a cavity essentially determining the shape of the composite molded part to be produced inside the device;

d) inserting an uncured support structure into the cavity;

e) removing a strip of the planar structure protruding beyond the border of the folded edge on the rear side of the composite molded part;

f) curing and subsequently

g) demolding the composite molded part, wherein steps d) to f) may be performed in a different order and/or to some extent simultaneously.

In order to achieve the initially stated object, such a method is characterized according to the invention in that during step c) of transferring the device in a closed position and during the creation of the cavity inside the device essentially determining the shape of the composite molded part to be produced, the outer border of the folded edge is fixed between two components moved in parallel with one another and is carried along with their closing movement, and that prior to and/or during the insertion of the uncured support structure in step d), the planar structure is fixed in the region of the outer border of the folded edge.

Thus, the precisely defined, reproducible production, which is possible accurately about any angles, of edge-folded borders of the planar structures of composite molded parts is substantially facilitated. By means of said fixing, precisely defined folded edges even of more than 90° can be obtained reliably and reproducibly in that the decorative film or any other planar structure used in the injection molding tool is folded into the edgefold geometry in a targeted manner. After back-injection molding and demolding, the component is fully edge-folded and trimmed. Further advantages are the economization of handling between the injection molding machine and the edge folding unit as well as the resulting shortening of the processing time of the component. Due to avoiding one to two process steps, a reduction of the scrap rate is also possible, as is the improvement of the edge folding quality, as the decor is permanently merged with the plastic melt and a later removal due to environmental influences can be precluded.

According to an advantageous variant of the method, the planar decorative structure (2) is fully edge-folded prior to or during the introduction of the uncured support structure in step d) and in any case prior to the removal of the strip of the planar decorative structure (2) protruding beyond the outer border of the folded edge on the rear side of the composite molded part in step e).

A possibility for the active shaping of the decorative film, textile webs, or other planar structures is that the planar structure, in particular the border region having the folded edge, is sucked onto and/or into the matrix and/or the curved region between matrix and matrix slider by applying a vacuum.

Another variant, however, provides that the planar structure, in particular the border region having the folded edge, is pressed onto and/or into the matrix and/or the curved region between matrix and matrix slider by applying an excess pressure.

In order to show the effect of the applied vacuum and/or the introduced compressed air even better, the distance between the components is preferably sealed at least while applying the vacuum and/or the excess pressure.

According to an advantageous further embodiment of the method according to the invention, the planar structure is pressed into the curved region of the matrix and/or matrix slider by means of at least one mechanical element.

Supportingly or alternatively to the abovementioned variants of the methods, the planar structure may be heated prior to and/or at least during the folding of the edge.

All mentioned method variants may also be used in any desired combinations.

### BRIEF DESCRIPTION OF THE DRAWINGS

For the purpose of better understanding of the invention, it will be elucidated in more detail by means of the figures below.

These show in a respectively very simplified schematic representation:

FIG. 1a a view of a composite molded part as it can be produced using a device according to the invention;

FIG. 1b a section through the composite molded part of FIG. 1a along line b-b;

FIG. 2 a schematic representation of a first embodiment of a device according to the invention in a closed position;

FIG. 3 the device of FIG. 2 in a fully opened initial position;

FIG. 4 the device of FIG. 2 in a fully opened initial position, but with an inserted decorative film as an example for a planar structure;

FIG. 5 the device of FIG. 2 during the closing process in a partially closed state;

FIG. 6 the device of FIG. 2 during the closing process in an almost closed state;

FIG. 7 the device of FIG. 2 in a fully closed state, in which all elements of the molding tool abut one another;

FIG. 8 a schematic representation of a second embodiment of a device according to the invention in a fully opened initial position;

FIG. 9 the device of FIG. 8 in a fully opened initial position, but with an inserted decorative film;

FIG. 10 the device of FIG. 8 during the closing process in a partially closed state;

FIG. 11 the device of FIG. 8 during the closing process in an almost closed state;

FIG. 12 the device of FIG. 8 in a fully closed state, in which all elements of the molding tool abut one another;

FIG. 13 a schematic representation of a third embodiment of a device according to the invention in a fully opened initial position, with an inserted decorative film;

FIG. 14 the device of FIG. 13 in a more widely opened state, at the beginning of compressed air being blown in;

FIG. 15 the device of FIG. 13 during the closing process in a partially closed state;

FIG. 16 the device of FIG. 13 in an almost fully closed state;

FIG. 17 the device of FIG. 13 in a fully closed state;

FIG. 18 a schematic representation of a fourth embodiment of a device according to the invention in a fully opened initial position;

FIG. 19 the device of FIG. 18 in a fully opened initial position, but with an inserted decorative film;

FIG. 20 the device of FIG. 18 during the closing process in a partially closed state;

FIG. 21 the device of FIG. 18 in a fully closed state;

FIG. 22 the device of FIG. 18 during the demolding process, with an extended punch slider;

FIG. 23 a schematic representation of a fifth embodiment of a device according to the invention in a fully opened initial position;

FIG. 24 the device of FIG. 24 in a fully opened initial position, but with an inserted decorative film;

FIG. 25 the device of FIG. 24 during the heating process of the inserted decorative film, in a partially closed state;

FIG. 26 the device of FIG. 24, still in an opened state, during the application of a vacuum and deformation of the inserted decorative film; and

FIG. 27 the device of FIG. 24 in a closed state, in which all elements of the molding tool abut one another.

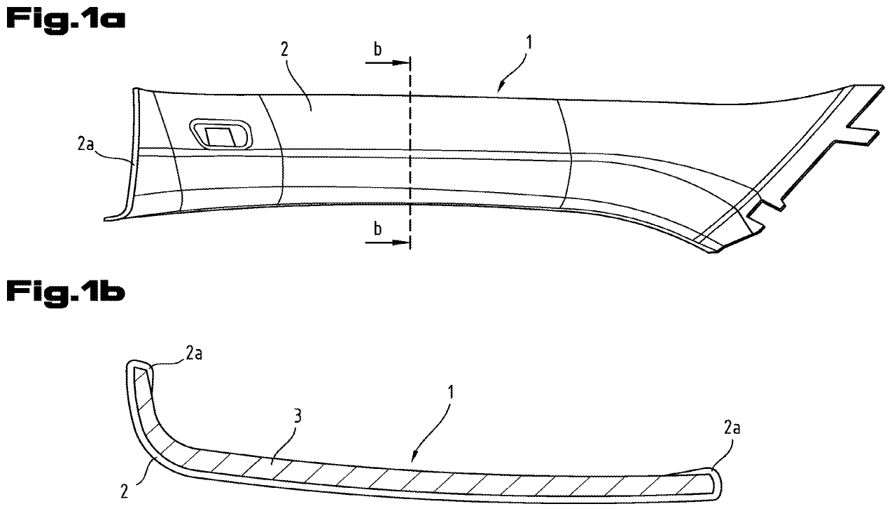

### DETAILED DESCRIPTION OF THE PREFERRED EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

Finally, as a matter of form, it should be noted that for ease of understanding of the structure, elements are partially not depicted to scale and/or are enlarged and/or are reduced in size.

The invention is used particularly in the production of back-injected composite molded parts 1, in which a planar structure 2, in particular a planar decorative structure such as, for example, a decorative film or a decorative fabric, envelops at least a part of the surface of the composite molded part 1. The structure 2 is back-injected with an initially liquid and subsequently curing support structure 3. The planar structure 2 has a folded edge 2a on the border of the molded part 1, which folded edge 2a may extend up to the border of the composite molded part 1, but also around the border, even all the way to the rear side not covered by a planar structure 2. Particularly preferably, such composite molded parts are used as trim components in the passenger compartment of vehicles.

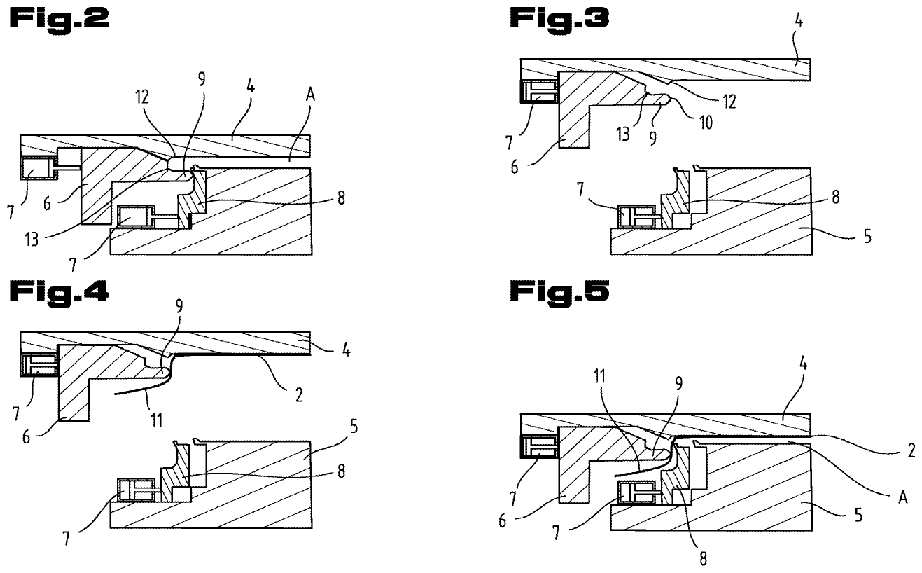

The device for producing such composite molded parts, schematically shown in a first embodiment in FIG. 2, comprises multiple mold elements arranged so as to be conventionally movable relative to one another by means of controllable drives, particularly a matrix 4 for receiving the planar decorative structure 2 (see FIG. 4) in a non-composite state, a punch 5, and a matrix slider 6. Due to the effect of the drives 7, shown here by way of example as fluidic power cylinders, the punch 5, the matrix 4, and the matrix slider 6 are arranged so as to be movable relative to one another such that in a closed state, they define a cavity A together, which essentially corresponds to the shape of the composite molded part 1 to be produced.

This first embodiment of a device according to the invention further has an advancing tool 8, which is arranged on a side wall of the punch 5 facing the matrix slider 6, preferably at least partially receivable in a recess of the punch 5. The matrix slider 6, in turn, has a protrusion 9 protruding towards the punch 5, preferably in the region of the upper border of the advancing tool 8.

On the outermost border of the protrusion 9 of the matrix slider 6, a cutting edge 10 is formed, which, in the closed state of the mold elements 4, 5, 6, 8, bridges the distance between the protrusion 9 of the matrix slider 6 and the punch 5, here preferably the advancing tool 8, to at least 80%. The cutting edge 10 may also be formed such that it bridges at least 90%, particularly preferably at least 95%, of the distance for an easy detachment of the protruding border strip 11 of the decorative structure 2, which detachment involves little stress on the surrounding region of the composite molded part. In the closed state of the device, the cutting edge 10 may also fully rest against the opposite component and thus sever the material of the planar structure 2 completely.

Instead of a continuous cutting edge 10, other designs are also possible, for example a series of individual pins or needles for achieving a perforation of the material of the planar structure 2 where its border strip 11 can be removed.

The matrix slider 6 and the advancing tool 8 are movable via their drives, in a parallel direction independently of one another, in particular movable towards one another such that a transition between the border strip 11 and the region of the planar structure 2 meant to remain on the composite molded part 1 can be gripped between these two components 6, 8 movable in parallel with one another, fixed, and edge-folded in a targeted manner and to any desired degree while the molding tool is closing.

A curved section 12 is formed on the matrix 4, and on the matrix slider 6, a curved section 13 is formed as well, which sections 12, 13 are directly opposite one another and form a first region defining the folded edge 2a of the planar structure 2 when the device is closed. The cutting edge 10 of the matrix slider 6 and the surface of the advancing tool 8 opposite the cutting edge 10 are spaced apart from the sections 12, 13 by the desired width of the folded edge 2a on the rear side of the composite molded part 1 and forms a second region, in which the region initially fixing and subsequently pinching off and/or fully severing the edge-folded border of the decorative structure 2 is formed.

For producing a composite molded part 1 as initially characterized, the device is brought into the opened position shown in FIG. 3. The matrix slider 6, as well, is moved fully outwardly, and the advancing tool 8 is extended completely from the punch 5. A not yet composite planar structure 2 is inserted into the matrix 4 of the device—as shown in FIG. 4—so that it corresponds to at least a part of a contour of the composite molded part to be obtained while protruding beyond its border with a border strip 11. The planar structure 2 may possibly already be provided with a partial folded edge.

Subsequently, the device is transferred into a closed position in order to thus finally form a cavity A essentially determining the shape of the composite molded part 1 between the mold elements 4, 5, 6, 8.

An intermediate position in this course of movement is shown in FIG. 5 with the matrix 4 and punch 5 having already approached one another, while the matrix slider 6 is moved towards the still fully extended advancing tool 8 only to a small degree.

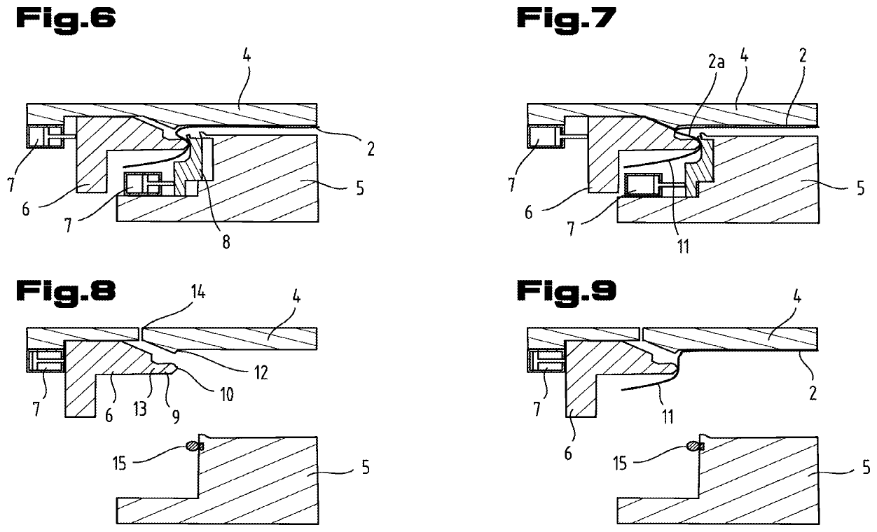

In further consequence, the matrix slider 6 is moved further towards the punch 5 and thus, the protrusion 9 of the matrix slider 6, in particular its cutting edge 10, finally comes into contact—or, as explained above, almost into contact—with the extended advancing tool 8. This causes that the material of the planar structure 2 is gripped and/or clamped between the protrusion 9 and the advancing tool 8 (see FIG. 6), and during the continued transfer of the device into the closed position, the outer border of the folded edge 2a of the planar structure 2 is fixed between the components matrix slider 6 and advancing tool 8, which components are now moved in parallel, and is carried along with their closing movement.

At the latest when the completely closed position of the mold elements 4, 5, 6, 8, shown in FIG. 7, is reached, the support structure 3, which is still liquid, is introduced in the cavity A. Subsequently, the removal of the strip 11 of the planar structure 2 protruding beyond the outer border of the folded edge 2a on the rear side of the composite molded part 1 and curing take place simultaneously or in any desired sequence. Finally, the device is opened again in order to demold the finished composite molded part 1. As adumbrated, some method steps may be performed simultaneously and/or in a different order.

By fixing the clamped border of the planar structure 2 between the matrix slider 6 and advancing tool 8 and actively carrying it along when closing the mold elements 4, 5, 6, 8, here particularly when the matrix slider 6 and the advancing tool 8 retract together, the planar structure 2 is fixed in the region of the outer border of the folded edge 2a prior to or during the introduction of the uncured support structure 3, and in any case is completely edge-folded before the strip 11 of the planar decorative structure 2 protruding beyond the outer border of the folded edge 2a on the rear side of the composite molded part 1 is removed. Thus, folded edges of more than 90° with a precisely predefined geometry of the folded edge can be produced in a simple manner.

A further embodiment of a device according to the invention is illustrated in FIG. 8 in an opened state. A suction opening 14 is leading out over at least one of the sides of the cavity A, which suction opening 14 can be connected to a device for air extraction (not shown). The side wall of the punch 5 facing the matrix slider 6 is provided with a seal 15.

For producing a composite molded part 1, the planar structure 2 is inserted into the opened device as shown in FIG. 9. The matrix slider 6 is also moved completely outwards, away from the punch 5. In this regard, a border strip 11 of the planar structure 2 protrudes beyond the region of the cavity A and in doing so extends beyond the protrusion 9 of the matrix slider.

Subsequently, the device is transferred into a closed position, during which the extraction of the air between the planar structure 2 and the matrix 4 through the suction opening 14 can already be started.

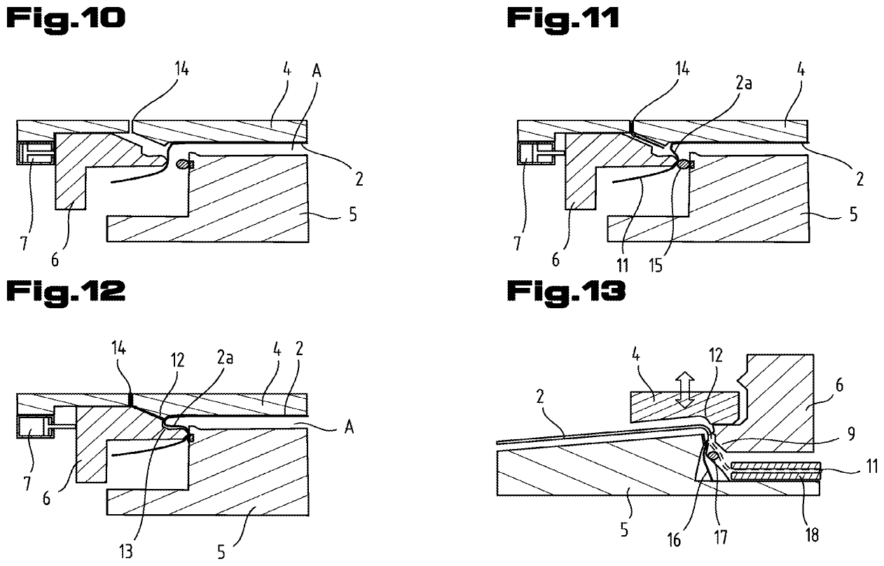

An intermediate position in this course of movement is shown in FIG. 10 with the matrix 4 and punch 5 having already approached one another, while the matrix slider 6 is moved towards the punch 5 only to a small degree.

In further consequence, the matrix slider 6 is further advanced towards the punch 5 and thereby, the protrusion 9 of the matrix slider 6 with its region directly outside the cutting edge 10—as viewed with respect to the cavity A—finally comes into contact with the seal 15 as is shown in FIG. 11. Thereby, one the one hand, the material of the planar structure 2 is gripped and/or clamped between the protrusion 9 and the punch 5 at the transition between the folded edge 2a and the border strip 11 to be removed. On the other hand, this also results in the effect of the applied vacuum being emphasized better.

During and after the continuation of the closing operation of the mold elements 4, 5, 6 of the device, the material of the planar structure 2 is sucked into the curved region 12, 13 between the matrix 4 and the matrix slider 6 and clings with the outer edge to said mold elements 4, 6 on the front side of the composite molded part as well as on the folded edge 2a, wherein the border region directly adjoining the folded edge 2a remains fixed between the matrix slider 6 and the punch, in particular between the protrusion 9 of the matrix slider 6 and the seal 15 on the punch 5, and is formed in accordance with the movement of the matrix slider 6. This position is shown in FIG. 12.

With respect to introducing the support structure that has not yet cured, curing, severing the border strip 11, and demolding the finished composite molded part 1, the explanations made regarding the first embodiment apply.

An exemplary position for the suction opening 14 is shown in FIGS. 11 and 12 on a position in the matrix 4, which is very far removed from the curved sections 12, 13 and/or the border of the cavity A. Advantageously, the suction opening 14 is located close to the most curved regions, wherein, however, it must be ensured that no material of the support structure 3 can clog the suction opening 14.

A further possibility for actively shaping the planar structure 2 in the device in the region of the folded edge 2a on the border of the composite molded part 1 is also to press its border region, by means of compressed air, against the arrangement of the curved sections 12, 13 provided for forming the folded edge 2a on the matrix 4 and the matrix slider 6. According to a further embodiment of the device according to the invention shown in FIG. 13, the punch 5 is provided with at least one compressed air feed 16 leading into the cavity A and connectable to a compressed air source (not shown) for this purpose. The cross-section of the compressed air feeds 16 and also of the suction openings 14 can have any shape as needed. Thus, round openings are possible, but also openings in the shape of elongated holes, which may be straight or also multiply curved, annular openings, etc.

In order to emphasize the effect of the compressed air even more, a seal 17 may again be arranged on the side wall of the punch 5. With respect to the folded edge 2a and the contact region of the protrusion 9 of the matrix slider 6 with the punch 17, the seal 17 is arranged so as to directly adjoin and outside on the side wall of the punch 5.

Advantageously, a clamping arrangement 18 for the protruding border 11 of the planar structure 2 is provided on the outer side between the matrix slider 6 and the punch 5.

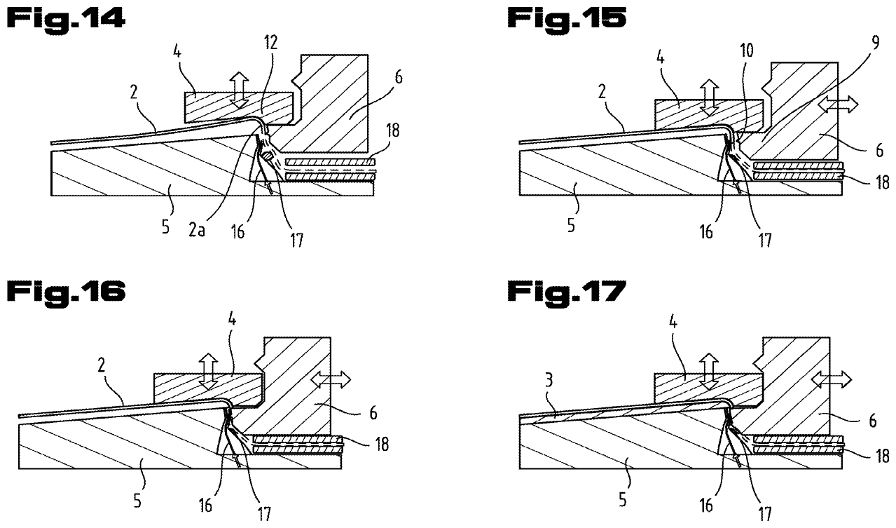

After inserting the planar structure 2 into the opened device of FIG. 13, the device is closed until the matrix slider 6 abuts with its protrusion 9 on the seal 17 despite its opened position removed from the punch 5, meaning that matrix 4 and punch 5 are made to approach one another. Then, compressed air is blown in through the compressed air feed 16, the planar structure 2 is inflated and clings to the matrix 4, in particular also in the curved border region 12 receiving a part of the folded edge 2a (see FIG. 14).

The closing process of the mold elements 4, 5 and now also that of the matrix slider 6 is further continued, just like the injection of compressed air. Finally, after going through the positions of FIG. 16, the completely closed state of the device is achieved, in which state the matrix slider 6 is displaced to a maximum towards the punch 5 and the cutting edge 10 severs the border region 11 of the planar structure 2, or prepares it for being severed by means of pinching off or perforating or similar processing, at the protrusion 9 of the matrix slider 6, which had so far only ensured the fixation of the border of the planar structure 2 and carried said border along in the course of the movement of the matrix slider 6, thereby edge folding it. During or after said processing on the folded edge 2a, the planar structure 2 is back-injected with the support structure 3. After curing, first, the matrix slider 6 is moved back into the opened position, subsequently, the matrix 4 and the punch 5 are as well, so that the finished composite molded part 1 can be demolded.

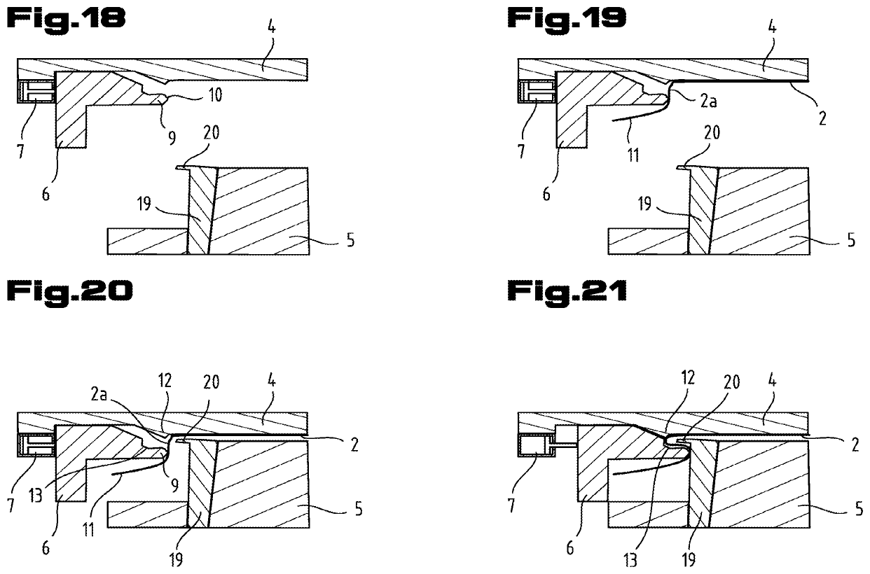

The molding of the curved section of the folded edge 2a on the border of the planar structure 2 can hereby also be effected by a further embodiment of the device according to the invention. This device shown in an opened state in FIG. 18 has a punch slider 19 on the side wall of the punch 5. This punch slider 19 is—as is shown in FIG. 21 in the context of demolding—not displaceable in parallel with the matrix slider 6, but in at least one direction transversely to the direction of movement of the matrix slider 6.

At its upper border, which comes to rest in the region of the folded edge 2a of the planar structure, the punch slider 19 is provided with an edge 20 protruding into the edge folding region. Instead of a continuous edge 20 or cutting edge, discrete, distanced protrusions, similar to those of a rake or a comb with a plurality of tines, or similar arrangements with the same effect, or combinations of such different elements may be present. In any case, these elements are movable, preferably extendable into the edge folding region in parallel with the direction of movement of the matrix slider 6 or in another direction.

After inserting the planar structure 2 into the matrix 4 into the fully opened mold elements 4, 5, 6 (FIG. 19), the device is partially closed once, wherein the edge 20 or elements with an equal effect hold the border region of the planar structure in the region of the curved section 12 of the matrix 4 when the matrix 4 and the punch 5 approach one another. In the subsequent closing process—see FIG. 20—of the matrix slider 6, as well, the border of the planar structure 2 is carried at the protrusion 9 and/or a cutting edge 10 formed there and in such a manner, the border region of the planar structure 2 is formed into the folded edge 2a. When the device is fully closed, the edge 20 projects into the curved region defining the folded edge 2a, which region is formed by the curved sections 12, 13 on the matrix 4 and the matrix slider 6. This position is shown in FIG. 21, wherein the border region 11 on the outer side of the folded edge 2a is subsequently pinched or severed between the cutting edge 10 of the matrix slider 6 and the surface of the punch slider 19.

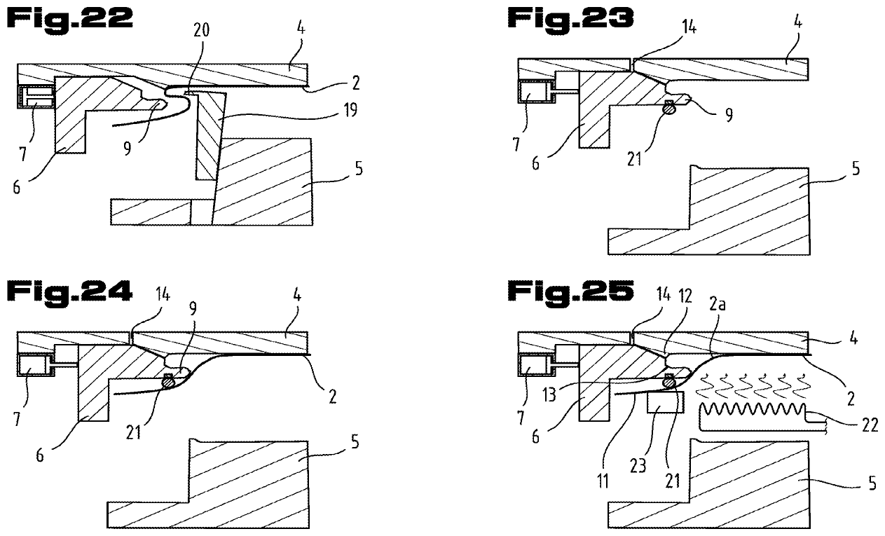

During demolding, as shown in FIG. 22, the punch slider 19 is preferably displaced away from the punch 5 towards the matrix 4 along an oblique direction with respect to the direction of movement of the matrix 4 and the punch 5. This results in that the edge 20 is extended inwardly out of the region inside the folded edge 2b and does not obstruct the demolding process.

A further embodiment provides for the active formation of the folded edge 2a by means of thermoforming of the planar structure. The device for this, again provided for the beginning of a cycle of the production process, is shown in FIG. 23. The mold elements 4, 5 are fully opened while the matrix slider 6, however, is closed in the direction towards the matrix 4. On the side of the protrusion 9 of the matrix slider 6 facing the punch 5, a seal 21 is arranged.

After inserting the planar structure 2, which is still cold,—as shown in FIG. 24—a heating element 22 is introduced into the tool, between the matrix 4 and the punch 5, for example via an automation system, a robot arm, or even manually. A heating element 22 may also possibly be installed in the punch 5, heating elements 22 may possibly be present alternatively or cumulatively in each of the mold elements 4, 5, 6.

Advantageously, a clamping frame 23 is also introduced into the tool or is an integral part thereof, which clamping frame 23 presses the decorative film 2 against the seal 21. Even while the or each heating element 22 is activated, the matrix slider 6, on the seal 21 of which the planar structure 2 is supported with its border region, still remains closed. Due to the heat of the heating element 22, the material is eventually softened, which results in a clinging to the contour of the matrix 4, in particular also in the curved edge folding region of the sections 12, 13. All other types of defined production of the folded edge 2a by means of active fixing and carrying along the edge-folded border region while closing the mold elements—as explained by way of example in the previous paragraphs in the context of the other exemplary embodiments of the invention—can be supported by softening the planar structure 2. Generally, all mentioned method variants may also be used in any combination, wherein the devices may be equipped with combinations of the described edge folding arrangements.

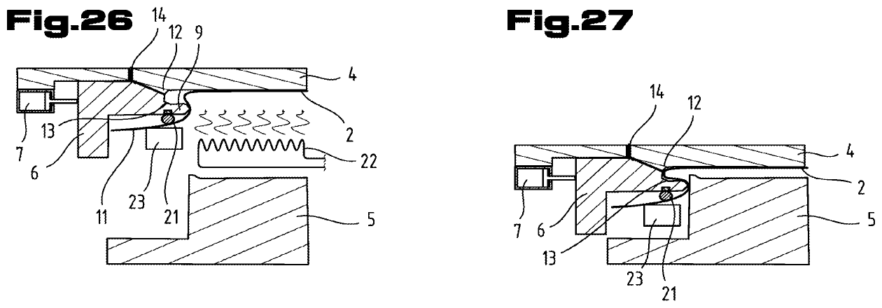

By way of example, FIGS. 23 to 27 show a suction opening 14 in the matrix 4, wherein the molding of the structure 2 is supported particularly in the actual edge folding region by applying a vacuum as the border region of the planar structure is sucked into the curved section 12, 13 and clings to the walls of the matrix 4 and the matrix slider 6.

Lastly, the mold elements 4, 5, 6 are closed, wherein the matrix slider 6 can possibly be opened slightly once more, and the device is brought into the position of FIG. 27. Subsequently, the border region 11 of the planar structure 2 is removed by means of pinching or cutting it off using the cutting edge 10 on the punch 5 or by means of completely severing it using the cutting edge, and the support structure 3 is introduced into the cavity between the mold elements 4, 5, 6 in any desired order. In certain variants of the method, in order to form the folded edge 2a, the border region is fixed during the closing process due to the friction at the seal 21 and is actively carried along during the closing movement of the matrix slider 6, forming the folded edge.

Due to the fixation of the border region of the planar structure on at least one of the mold elements 4, 5, 8 or between two mold elements 6, 8, which is provided in all embodiments according to the invention, precisely defined folded edges, even of more than 90° can be obtained reliably and reproducibly in that the border of the structure 2 in the injection molding tool is folded into the edgefold geometry in a targeted manner. This is preferably defined by the curved sections 12, 13 on the mold elements, in particular the matrix 4 and the matrix slider 6. After back-injection molding and demolding, the composite molded part 1 is fully edge-folded and trimmed.

### LIST OF REFERENCE NUMBERS

1 Composite molded part
2 Planar structure
2a Folded edge
3 Support structure
4 Matrix
5 Punch
6 Matrix slider
7 Drive
8 Advancing tool
9 Protrusion matrix slider
10 Cutting edge matrix slider
11 Border strip
12 Curved section matrix
13 Curved section matrix slider
14 Suction opening matrix
15 Seal punch
16 Compressed air feed
17 Seal punch
18 Clamping arrangement
19 Punch slider
20 Edge punch slider
21 Seal matrix slider
22 External heating element
23 Clamping element
A Mold cavity

1-17. (canceled)

18. A device for producing a composite molded part (1) having a planar structure (2), in particular a planar decorative structure, enveloping at least a part of the composite molded part, in particular a part of the surface of the composite molded part, and an at least partially injected support structure (3), comprising a matrix (4) for receiving the planar structure (2) in a non-composite state, a punch (5) and a matrix slider (6), wherein punch (5), matrix (4), and matrix slider (6) are arranged so as to be movable relative to one another, such that in a closed state, they define a cavity (A) together, which essentially corresponds to the shape of the composite molded part (1) to be produced,
wherein
an edge folding arrangement having a first curved region (12, 13) defining the folded edge and having a second region (8, 9, 10, 15, 17, 20, 21), spaced at a distance from the first, which fixes and/or pinches off and/or completely severs the edge-folded border of the planar structure (2), is formed by at least one region and/or on at least one region of one of the components matrix slider (6), punch (5) and/or matrix (4),
wherein
the punch (5) has an element for fixing the planar structure that is movable in a direction parallel to the matrix slider (6) in the region of its side wall, which region is facing the matrix slider (6).

19. The device according to claim 18, wherein in the second region (8, 9, 10, 15, 17, 20, 21), at least one of the components matrix slider (6), punch (5), or matrix (4), preferably the matrix slider (6), has a cutting edge (10), which in the closed state bridges a distance between an opposite component to at least 80%, preferably at least 90%, particularly preferably at least 95% until almost contacting the opposite surface.

20. The device according to claim 18, wherein the matrix (4) and the slider (6), in the closed state, together form the first region (12, 13) of the cavity (A) defining the folded edge, and the cutting edge (10) is formed on a, preferably protruding, border (9) of the slider (6) facing the punch (5).

21. The device according to claim 18, wherein the element movable in a parallel direction to the matrix slider (6) is an advancing tool (8), wherein the matrix slider (6) and the advancing tool (8) are movable independently of one another.

22. The device according to claim 19, wherein the matrix (4) has at least one suction opening (14) leading out of the cavity (A), which suction opening (14) can be connected to a device for air extraction.

23. The device according to claim 19, wherein the punch (5) has at least one compressed air feed (16) leading into the cavity (A) and connectable to a compressed air source.

24. The device according to claim 22, wherein a seal (17) is installed on the side wall of the punch (5), directly adjoining the contact point with the matrix slider (6) on the outside of the cavity (A).

25. The device according to claim 19, wherein in the region of its side wall facing the matrix slider (6), the punch (5) has an element (19) that is movable in a direction parallel to the matrix (4), which element (19) has an edge (20) or an arrangement of parallel fingers projecting into the edge folding region (12, 13), which are possibly extendable in the direction of the curved region (12, 13).

26. The device according to claim 19, wherein a heating arrangement (22) for the planar structure (2) is provided, possibly on at least one of the components matrix (4), matrix slider (6) and/or punch (5).

27. A method for producing a composite molded part (1) with a planar structure (2), preferably a decorative structure, enveloping at least a part of the surface of the composite molded part, and an at least partially injected support structure (3), comprising the steps of:
a) providing a device with at least a punch (5), a matrix (4), and a matrix slider (6) in an open position;
b1) inserting a not yet composite planar structure (2) into the device, such that the planar structure corresponds to at least a part of a contour of the composite molded part (1) to be obtained;
b2) optionally using a planar structure (2) partially preformed with a folded edge;
c) transferring the device into a closed position and creating a cavity (A) essentially determining the shape of the composite molded part (1) to be produced inside the device;
d) inserting an uncured support structure (3) into the cavity;
e) removing a strip (11) of the planar structure (2) protruding beyond the border of the folded outer edge on the rear side of the composite molded part (1);
f) curing and subsequently
g) demolding the composite molded part (1), wherein steps d) to f) may be performed in a different order and/or to some extent simultaneously;
wherein
during step c) of transferring the device in a closed position and during the creation of the cavity (A) inside the device essentially determining the shape of the composite molded part (1) to be produced, the outer border of the folded edge (2a) is fixed between two components moved in parallel with one another and is carried along with their closing movement, and prior to and/or while introducing the uncured support structure (3) in step d), the planar structure (2) is fixed in the region of the outer border of the folded edge (2a).

28. The method according to claim 27, wherein, the planar decorative structure (2) is fully edge-folded prior to or during the introduction of the uncured support structure in step d) and in any case prior to the removal of the strip (11) of the planar decorative Structure (2) protruding beyond the outer border of the folded edge (2a) on the rear side of the composite molded part (1) in step e).

29. The method according to claim 27, wherein the planar structure (2), in particular the border region having the folded edge (2a), is sucked onto and/or into the matrix (4) and/or the curved region (12, 13) between matrix (4) and matrix slider (6) by applying a vacuum.

30. The method according to claim 27, wherein the planar structure (2), in particular the border region having the folded edge (2a), is pressed onto and/or into the matrix (4) and/or the curved region between matrix (4) and matrix slider (6) by applying an excess pressure.

31. The method according to claim 29, wherein the distance between the components is sealed at least during the application of the vacuum and/or the excess pressure.

32. The method according to claim 27, wherein the planar structure (2) is pressed into the curved region of matrix (4) and/or matrix slider (6) by means of at least one mechanical element (20).

33. The method according to claim 27, wherein the planar structure (2) is heated prior to and/or at least during the edge folding process.
